(19) United States
(12) Patent Application Publication
(10) Pub. No.: US 2005/0183342 A1
(43) Pub. Date: Aug. 25, 2005

(54) Finger safe shield

(76) Inventor: Nick J. Holden, Waco, TX (US)

Correspondence Address: NICK J. HOLDEN, P.O. BOX 5495, WACO, TX, 76708, US

(21) Appl. No.: 10/784,265

(22) Filed: Feb. 24, 2004

(51) Int. Cl. E06B 7/16

(52) U.S. Cl. 49/383

(57) ABSTRACT

This “Shield” is rectagular shaped, designed to cover the hinged side of any door, from top to bottom, to prevent hands and fingers from being crushed when closing the door. In the history of doors I have not found anything for this application. Therefore this type of “Shield” is necessary for child safety. Which makes it new. The “Shield” itself can be made of many types of materials such as plastics etc. The dimensions depend upon each door size. The mechanical function of the “Shield” can vary depending on the type of door. When this “Shield” is installed on a door, it covers the entire opening of the hinged side of the door, making it impossible to put anything in the opening. The concept of the “Shield” is child safety.

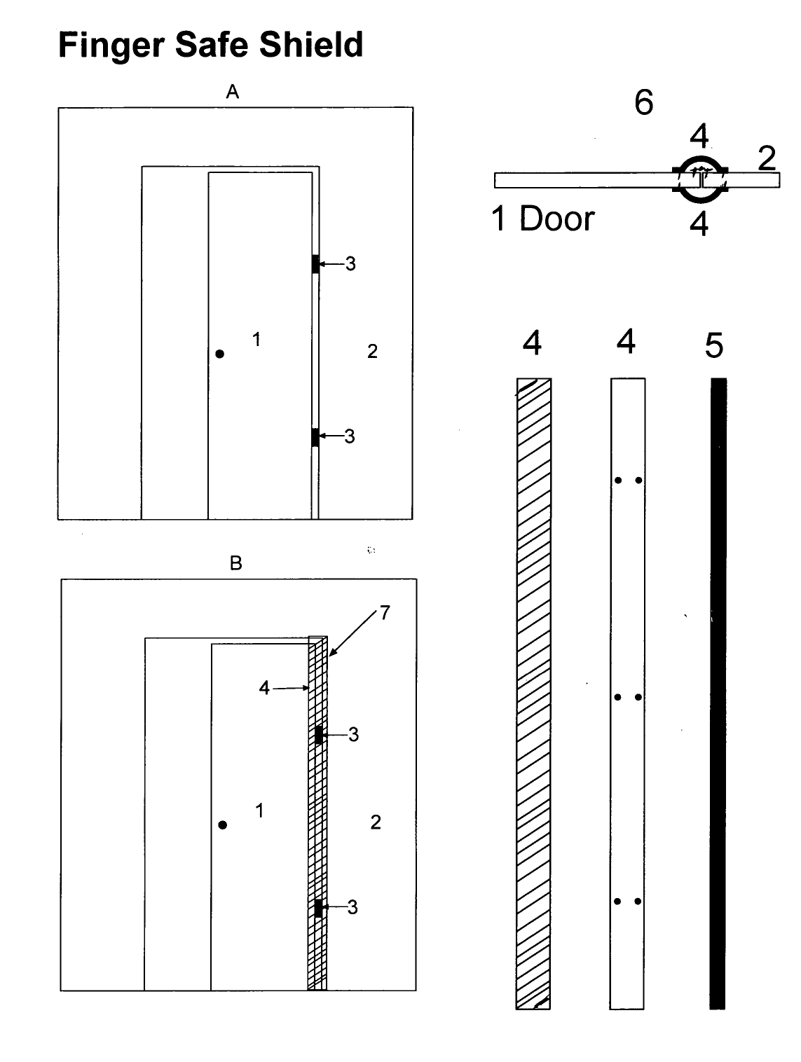

### FINGER SAFE SHIELD FOR ANY DOOR

The shield prevents anything from getting in the crack of the hinged side of the door, Therefore, its impossible for hands and fingers to be caught in the door when closing.

The shield, when installed, covers the opening (hinged side) of the door from Top to bottom, on both sides, inside and outside of the door.

The shield itself can be made with many different types of materials, such as plastics, etc. The dimensions will depend upon the size of the door. For example:

A 6 ft. 8 inch door the shield would be 6 ft. 8 inch in highth, approx. 4 inchs. Wide and Depending on the material used, approx. ⅛ inch thick. So, therefore, a shield would Be approx. 6 ft. 8 inchs high, 4 inchs wide and ⅛ inchs thick.

With this shield, it would make it impossible for a child to get their fingers mashed.

| | | |
|---|---|---|
| In sketch “A” it shows | 1. | DOOR. |
| The opening between the | 2. | Hinged side of door jam. |
| Hinged side of the door | 3. | Door Hinges. |
| In sketch “B” it shows | 4. | Face view of shield |
| With the shield installed | 5. | Side view of shield. |
| Its impossible to put fingers | 6. | Top view looking down |
| | | on door, shield and hinged |
| | | side of door jam |
| In the door opening (hinged side) | 7. | Shield attached to door and |
| | | hinged side of door jam. |

1. The shield is flat rectangular shaped to cover the opening of the hinged side of a door. The shield can be made with many different materials such as plastic etc.

2. The shield dimensions will depend upon the type and size of the door

3. A shield for a door 6 ft. 8 in. would be 6 ft. 8 in. in hieght and approximately 4 in. wide and ⅛ in thick strip of plastic or other material. The shield can be manufactored many different ways and materials, as it is only a flat rectangular shape strip of material to mount over the hinged side opening of a door to prevent children from crushing thier fingers as the door is closed.
